(19) United States
(12) Patent Application Publication
(10) Pub. No.: US 2023/0281566 A1
(43) Pub. Date: Sep. 7, 2023

(54) LIFE INFORMATION PROVIDING DEVICE

(71) Applicant: Eigai HAMADA, Fujisawa-shi, Kanagawa (JP)

(72) Inventor: Eigai HAMADA, Fujisawa-shi, Kanagawa (JP)

(21) Appl. No.: 18/000,517

(22) PCT Filed: Oct. 26, 2021
(86) PCT No.: PCT/JP2021/039379

§ 371 Date: Dec. 2, 2022

(51) Int. Cl. G06Q 10/107; G06Q 50/26; G06Q 50/22

(52) U.S. Cl. CPC G06Q 10/107; G06Q 50/265; G06Q 50/22

(57) ABSTRACT

[PROBLEMS]

A large amount of life information related to unsafe factors of human life such as illness, child abuse and traffic accident are issued by information providing organizations such as national and local governments and academic organizations. If such life information is not received by target persons properly, it is delayed to deal with it and the person may suffer a disadvantage or a danger to life.

[MEANS OF SOLVING THE PROBLEMS]

The invention receives information from the information providing organizations and registers the information as life information for each of the unsafe factors. Further, the invention extracts target-person characteristics such as gender, date of birth and a regional characteristic included in the information. The life information is provided by e-mail to registered users who match the extracted target-person characteristics without delay and without failure to receive it.

### TECHNICAL FIELD

A technical field is that information provided by information providing organizations such as national and local governments, academic organizations and news organizations is recognized and registered as life information related to unsafe factors such as illness, child abuse (maltreatment), a traffic accident and the like harming safety of human life to provide users who are to be target persons of the life information with the life information together with previous life information without delay or without failure to receive the life information.

### BACKGROUND ART

The information from the information providing organizations which are professional in their respective fields, such as the national and local governments and the academic organizations is directly transmitted to related organizations. However, such information is provided to the general public mainly via the Internet. In addition, important information or highly common information among such information is picked up by the news organizations such as television companies and newspaper companies and is provided through their respective means.

### RELATED ART DOCUMENT

### Patent Document

Patent Document 1 is JP 2006-260081 A
Patent Document 2 is JP 2010-152845 A

### SUMMARY OF THE INVENTION

### Problems to be Solved by the Invention

The life information, which is related to the unsafe factors such as the illness, the child abuse, the traffic accident and the like harming the safety of the human life and is provided by the information providing organizations such as the national and local governments and the academic organizations, is provided to the general public mainly via the Internet. However, since the amount of such information is large and such information is not provided to the target persons, it is unknown whether or not the target persons can properly receive such information.

The important information or the highly common information among such information is also provided through the news organizations such as the television companies and the newspaper companies. This means that there are more opportunities for users to receive the important and highly common information. However, the important and highly common information is also provided in large amounts. Further, such important and highly common information is reported temporarily and intensively for a short period of time. For these reasons, it is unclear whether or not such important and highly common information will be reliably received. In particular, if target users are busy at that time or are on an overseas business trip, they will often miss the receipt. Among such information, if the information related to the unsafe factors of the human life cannot be received, it is delayed to deal with it and suffer a disadvantage. In the worst case, there will be a danger to life.

In addition, although such information is often provided without previous information provided before that time, the previous information and countermeasures may be important. Thus, if such previous information is not transmitted, it may be inadequate to deal with it.

These points are the problems to be solved by the present invention.

### Means of Solving the Problems

A life information providing device receives information from information providing organizations such as national and local governments and academic organizations, specifies which item of unsafe factors of human life the information is related to, extracts target-person characteristics such as gender, age and region which are to be targeted for the information and provides registered users who match the characteristics with the information as life information by e-mail. Thereby, the users can receive necessary information without delay and without failure to receive it.

Further, the previous life information related to the above information is also registered in the life information providing device to provide the previous life information at the same time when providing the latest life information. This allows the users to obtain the life information that is systematically organized, including the previous information.

### Effects of the Invention

The users who are to be the target persons for the above information can receive the life information related to the unsafe factors of the human life provided by the information providing organizations together with the previous life information by e-mail without delay and without failure to receive it. Therefore, it is possible to eliminate the related unsafe factor and enhance the safety by dealing with it based on the received life information.

### BRIEF DESCRIPTION OF THE DRAWINGS

FIG. 1 is an overall view of a life information providing device.

FIG. 2 is an example of life information.

FIG. 3 is a flow of constructing a life information database.

FIG. 4 is an item table of unsafe factors of the life information providing device.

FIG. 5 is a flow of providing the life information (for new information).

FIG. 6 is a flow of providing the life information (at the time of updating user characteristics).

FIG. 7 is a flow of providing the life information (at the time of user request).

FIG. 8 is an example of registered user information.

FIG. 9 is a flow of providing the life information (for abuse or bullying).

### MODE FOR CARRYING OUT THE INVENTION

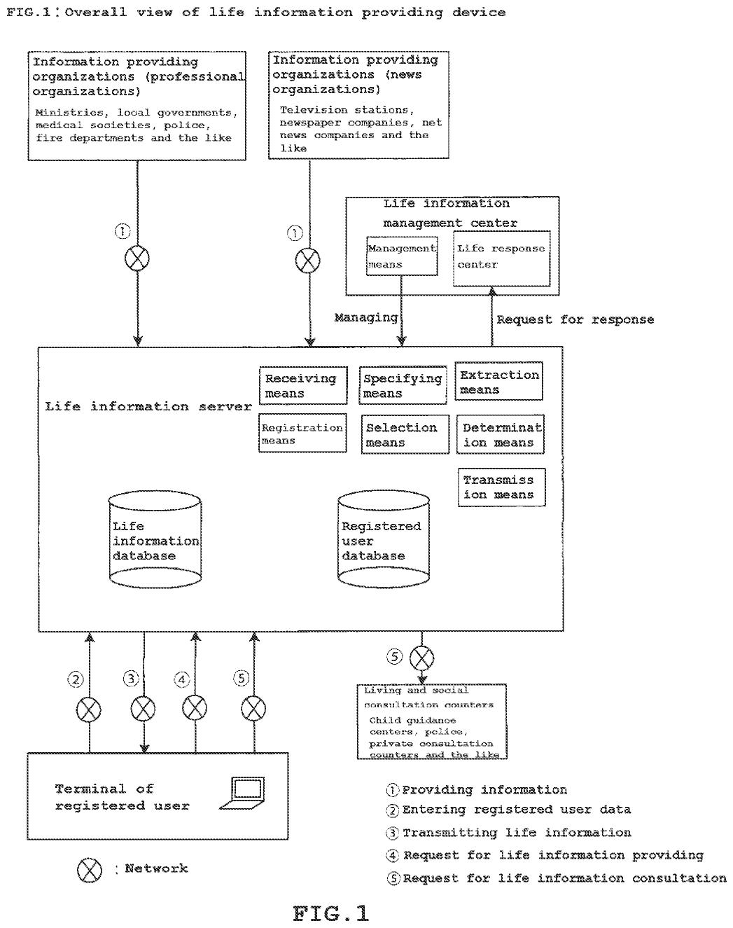

As shown in FIG. 1, the life information providing device has a configuration centered on a life information server, and has a life information database and a registered user database in the server. Further, as functions of the device, the life information providing device has receiving means, specifying means, registration means, extraction means, selection means, determination means and transmission means using computer hardware. Furthermore, the life information providing device is connected to a terminal of each of the registered users via the receiving means and the transmission means using a network.

There are professional information providing organizations which are professional in their respective fields such as national ministries, local governments, medical societies, police and fire departments. Further, there are general information providing organizations which serve as news organizations such as television stations, newspaper companies and net news companies that simply provide information. Countermeasures in the life information are usually provided by the professional information providing organizations.

The life information database is a database which organizes the life information by each of items of the unsafe factors classified through a wide range of fields. Further, when new information is issued, the life information database is configured to register and save the new information by classifying the new information for each unsafe factor that causes the new information. On the other hand, before the life information providing device begins to provide information, their previous information and countermeasures are registered and saved therein. Thereby, when providing the new life information, it is possible to provide the previous information together with the new life information. This can help to enhance usefulness of the entire life information.

The registered user database is a database which registers and saves information of the registered users who use the life information providing device. Each of the registered users is asked to enter data of user characteristics such as gender, date of birth, a residence area and a work area, and also enter vaccination status against epidemic diseases and history of a traffic safety course (traffic safety training program) of each registered user. The entered information is registered and saved in the registered user database.

In order to smoothly transmit information issued by the information providing organizations to the target persons for the information together with previous information and countermeasures considered by experts for the same unsafe factor as the information, it is prepared in advance by taking up a wide range of the unsafe factors, examining previous case information, and organizing the life information including risks and countermeasures for each unsafe factor to register and save the life information in the life information database. Then, in order to organize the information and provide it more usefully, “basic policy for providing life information”, “concept of countermeasures” and “construction of database of life information” are defined in the following.

(Basic Policy for Providing Life Information)

Regarding the safety of the human life, it is difficult to unambiguously decide what is safe. The safety of the human life can be achieved by protecting the target person from various factors harming the safety of the human life such as the illness, the child abuse and the car accident. For these reasons, it is necessary to provide information and countermeasures for each of these factors. Therefore, these factors harming the safety of the human life are recognized as the unsafe factors, and the information and the countermeasures for each of the unsafe factors are collected and stored in the life information database as the life information.

The main function of the life information providing device is to transmit the newest information. In order to properly classify new information when the new information is issued and in order to promptly provide the life information, it is necessary to properly organize and classify the previous life information up to that point for each of the unsafe factors and compile it in the life information database.

Then, in order to recognize the unsafe factors that are dangerous to the human life in a wider range and prepare the countermeasures, it is organized as follows.

“The safety of the human life is separately examined in various specialized fields. For example, the medical science generally teaches us what to do after getting sick and improves the safety of the human life. However, in order for a person to protect his or her life in society, he or she must prevent a traffic accident when going out of a house. Further, when he or she comes into contact with or interacts with an outsider, it is desirable to avoid a terrible situation for safety. Many of these problems of the safety of the human life have not been established as specialized academic fields. In this regard, countermeasures of the problems are communicated by parents and others in the vicinity based on their knowledge and are learned from experience. However, it is not possible to deal with a problem that people have not known or have not experienced, and it is delayed to deal with it, leading to increased damage and a crisis of the human life. In addition, the current academic fields related to the safety do not have a perspective of comprehensively protecting lives of individuals, but only a perspective of each specialized field such as the medical science. Unless the individuals have a supernatural power, it is difficult to check all of the many unsafe factors in the world and secure a wider range of safety.”

(Concept of Countermeasures)

In order to make the provided countermeasures more useful, the basic idea of protecting the human life is defined as follows.

The basic idea of “protecting the human life”:

(1) A subject who protects his or her own life from unsafe factors is, first and foremost, the person himself or herself. Government offices and neighbors are not considered to be subjects who protect lives of individuals, but are considered to support them.

(2) Each person understands that the person himself or herself protects his or her life in the first place, and that the people around him or her also protect their lives in the same way to cooperate as much as possible with each other as human beings protecting their own lives.

(3) It is considered that individuals become independent of others and able to protect their own lives only after they reach adulthood around the age of 18. The previous stage is divided into two stages. The first stage is from the time of the fetus to the age of 12, in which the guardian (parent or its agent) becomes the subject in protecting the life of the young person (protected person). The second stage is the period from the age of 12 to the age of 18 when the subject who protects the life is changed from the guardian to the protected person. In the second stage, the guardian teaches the protected person to protect his or her life, guides the protected person to act independently, and supplements a lack of knowledge and experience so that the protected person can become independent when the protected person is around 18 years old.

The age dividing each of the stages is a general age, so if the guardian judges that it would be better to shift the age, the guardian talks to the protected person and makes adjustments after mutual understanding.

(4) Abuse and bullying are acts of obstructing neighbors who protect their lives, and acts of ignoring the essence of protecting the human life. In other words, a person who abuses or bullies is a person who does not understand the essence of the human life, not a true person who lives in society. Therefore, even if such a person is no longer recognized as a human being by society or is punished by law, such a person is deemed to be unavoidable. The abuse and bullying are thought to result in acts that allow the person doing the abuse and bullying to be bullied (or to be a sate bullied) in reverse. Therefore, the basic premise is that all human beings are willing to have the idea that if they are human beings, they will not abuse or bully, and that they will not let the abuse and bullying happen.

(5) Nevertheless, having the idea of “I want to be superior to others. I want to show off my strength by securing those weaker than me” is one of the natures of the human beings. For this reason, the abuse and bullying are not likely to be disappear. In addition, when “parent-to-child abuse or bullying” or “husband-to-wife domestic violence” occurs, there is no one between them. For this reason, it is considered extremely difficult for the victim to escape from it. Therefore, in order to deal with this problem, a third-party guardian who is not a parent or husband is required. In this regard, as the countermeasures, it is considered that the chairman of the self-governing body who is the head of the smallest self-governing unit, or alternatively the head of the municipality becomes the third-party guardian. Further, it is considered that child counselors and police officers who are consulted about the parent-to-child abuse and the husband-to-wife domestic violence will work with the third-party guardian to help to solve the problem by multiplying the response to this problem.

(Preparation of Life Information Database in Advance)

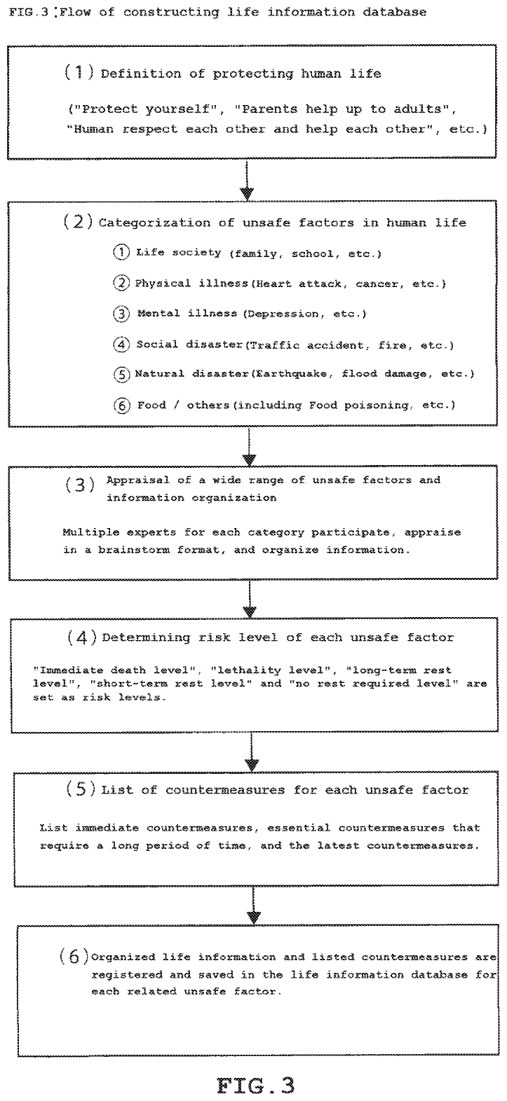

Registration of the life information data into the life information database up to the time when the life information providing device starts operation is performed according to the flow of FIG. 3. As shown in (2) of FIG. 3, in order to systematically examine the unsafe factors of the human life through a wide range of fields, categorization is performed for convenience. In the life information providing device, the unsafe factors are divided into six categories: “life safety”, “mental illness”, “physical illness”, “social disaster”, “natural disaster” and “food/others”.

Then, as shown in (3) to (6) of FIG. 3, a plurality of experts and university professor-level intellectuals in each of items of the unsafe factors in these categories are asked to make a list of the unsafe factors within each category. Next, the life information is organized by the items of each unsafe factor in each category, such that effective countermeasures are summarized as the life information to register and save the organized and summarized life information in the life information database.

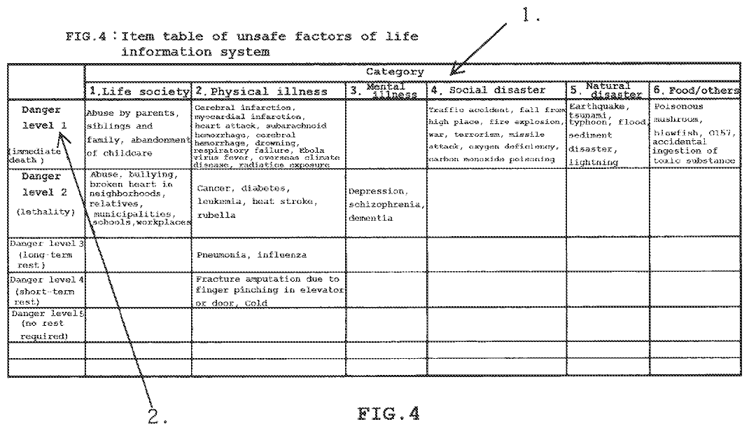

FIG. 4 shows an example of a table in which the items of the unsafe factors in the life information providing device are analyzed for each category to determine the danger level thereof. The items capture a wide range of the unsafe factors in general social life. Thus, if the life information about the items is available, the newest information and countermeasures will be available without hassles of looking at what is written in “family medical science” books or reading newspaper articles. This can help to improve the safety of normal life.

(Preparation of Registered User Database and Update of Registered Data)

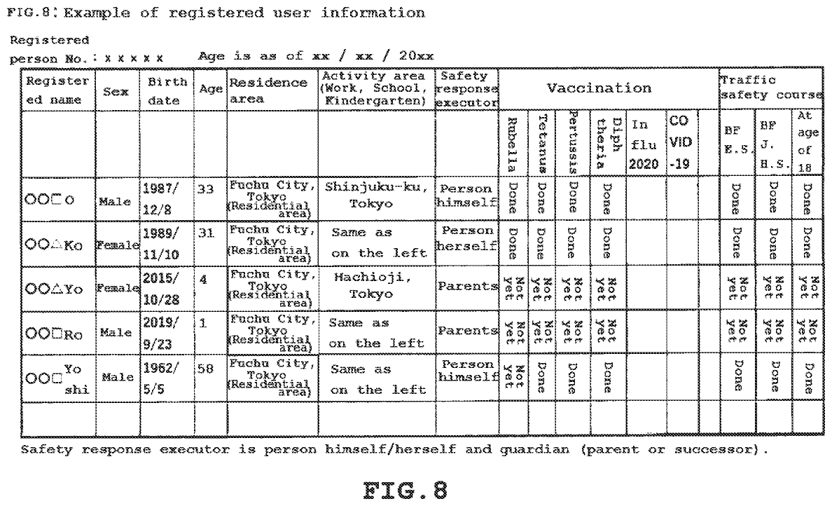

Each user of the life information providing device performs a registration so that it is possible to obtain life information suitable for the user. FIG. 8 is an example of registered user information. Items to be registered are “name”, “gender”, “date of birth”, “residence area”, “activity area”, “whether or not the user has been vaccinated against major epidemic diseases” and “whether or not the user has taken a traffic safety course”.

In addition, the registered information in these items may be updated due to changing the residence area, performing the vaccination or taking the traffic safety course. In that case, the registered user can perform the update to receive more suitable information and countermeasures that match an actual situation of the user. Further, when the user receives the newest life information, the user can judge a lack of own registered information and the necessity of additions. This makes it possible for the user to take optimal measures to improve the safety based on both the data provided by the life information providing device and the actual situation of the user.

Furthermore, for example, when triple combination vaccines (against diphtheria, pertussis and tetanus) are vaccinated, this is recorded in a mother-child health handbook. Thus, it seems that the mother remembers it. However, if the mother-child health handbook is lost after a long period of time passes, it becomes difficult to take countermeasures because the user's situation cannot be known. In such a case, if the registered user database is used as a memorandum, it is very likely to prevent misunderstanding of the situation and to take measures based on the correct information. Moreover, if the residence area is changed from a rural area to an urban area at the time of taking a traffic safety course, the traffic safety course of the rural area may not be useful. This is because traffic situations between the rural area and the urban area are different from each other. In such a case, it is possible to help to prevent traffic accidents in the urban area by judging from the information registered in the registered user database, moving to the urban area and then taking the traffic safety course of the urban area. In this way, the registered user data can be used.

The registered user information is provided when new life information is entered or when the user characteristics change. This makes it possible to check the registered user information each time. Further, it is useful to print it out so that it can be referred to even during normal times.

(Deal with New Information)

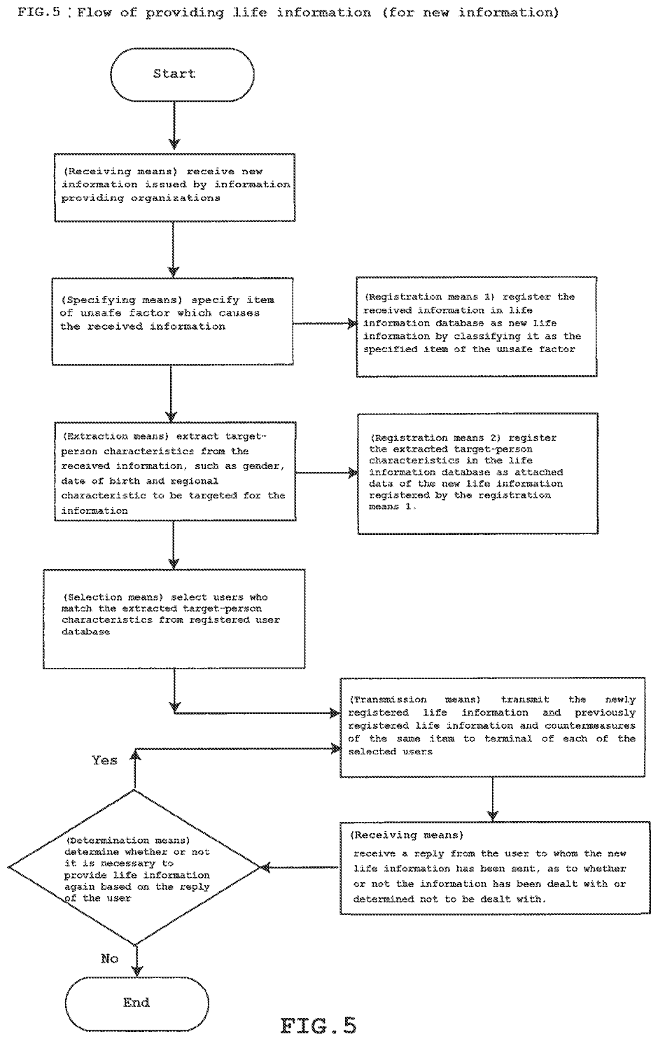

In a flow of providing information according to the life information providing device as shown in FIG. 5, when new information such as rubella epidemics, child abuse, and traffic accidents caused by road rage is issued by the professional information providing organizations including each ministry such as the Ministry of Health, Labor and Welfare, the local governments, the medical societies, the police and the fire departments, the new information is received as new life information. Next, which item of the unsafe factors causes the received new life information is specified. Then, the new life information is registered and saved in the specified item of the life information database after digitalization thereof.

At the same time, characteristics such as the gender, the age (date of birth) and the region of target persons who need the information are extracted from the new life information and registered as attached data (appendix data) of the newly registered life information. Next, the target persons matching the extracted characteristics are selected from the registered user database, and the newly registered life information is transmitted to the terminal of each of the target persons (selected users). At this time, the previous life information in the item is also transmitted thereto.

As a result, the users who are the target persons of the information can obtain the life information which is necessary for the users and is systematically organized including the previous life information without delay and without failure to receive it. Thus, the users can avoid danger related to the life information.

For example, it is assumed that the information “if a man born in 1962-1978 has not been vaccinated against rubella and has rubella and there is a pregnant woman around the man, there is a concern that the fetus may cause a disorder such as congenital heart disease” is issued on the Internet from the Ministry of Health, Labor and Welfare. At this time, if the technology of this application is applied thereto, the item to be targeted of the unsafe factor is specified as “rubella” from this Internet information. Then, this life information is registered and saved as new information of the unsafe factor “category 2. physical illness-rubella” in the life information database. Further, the characteristics of the target persons who need this information are extracted as target-person characteristic data including the gender “male”, the age “born in 1962-1978” and the region “Japan” that is the default because there is no particular description for the region in this information. The target-person characteristic data is registered and saved as attached data of this life information. Furthermore, users who match the extracted target-person characteristic data are selected from the registered user database. In addition, the newly registered life information and the previous life information in the item (rubella) of the unsafe factor are sent to the users by e-mail. This allows the users to receive this information without delay and without failure to receive it, thereby helping the users to steadily prevent the danger associated with this information.

In order for the general public to receive such information, it is necessary to constantly search the Internet. Thus, it is impossible to steadily receive all of the information from the professional information providing organizations. In addition, such information is temporarily transmitted through general TV and newspapers. At this time, if a person is too busy to watch newspapers, TV and Internet news or is on a business trip or stationed overseas, it is quite possible that the person fails to receive this information. In addition to such cases, considering a case where individuals have not received the information from the information providing organizations, the life information providing device of this application examines “persons who need the life information” to allow each of the persons to receive the life information without delay and without failure to receive it. Namely, it is possible to transmit the information regarding the unsafe factors of the human life issued by the professional information providing organizations without delay and without omission by using the hardware, that is, the life information providing device.

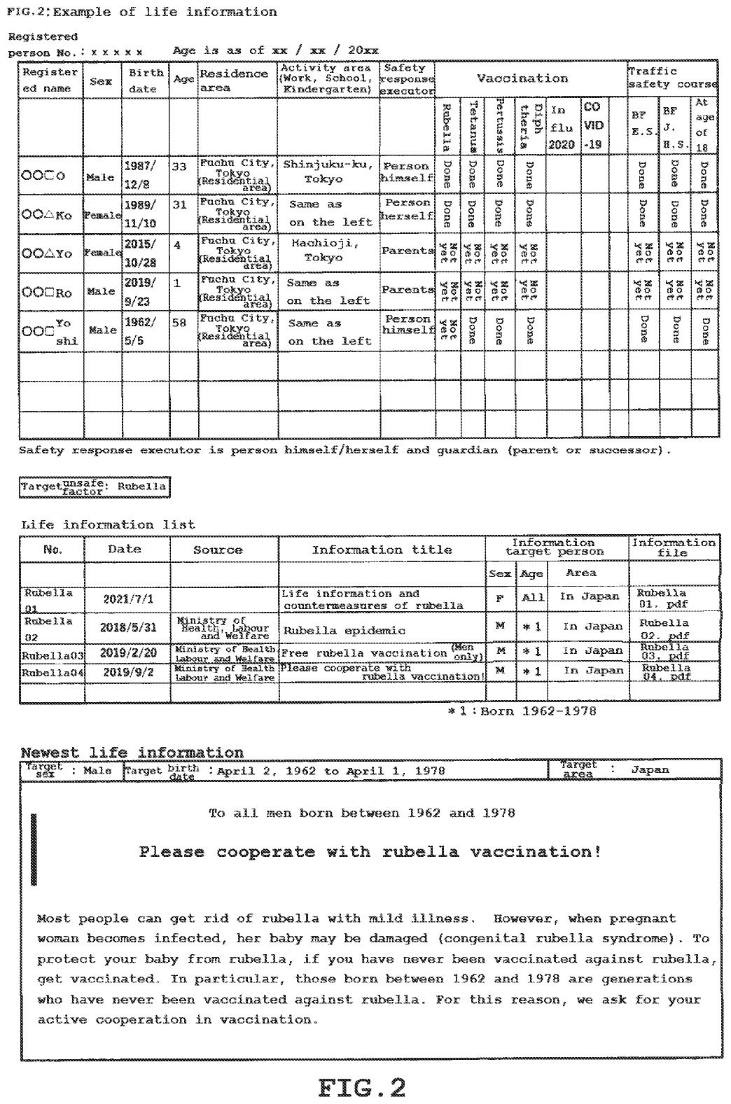

FIG. 2 is an example of a list of life information provided. Since the previous life information can be referred to, it is possible to more effectively prevent the unsafe factors that are dangerous to the human life.

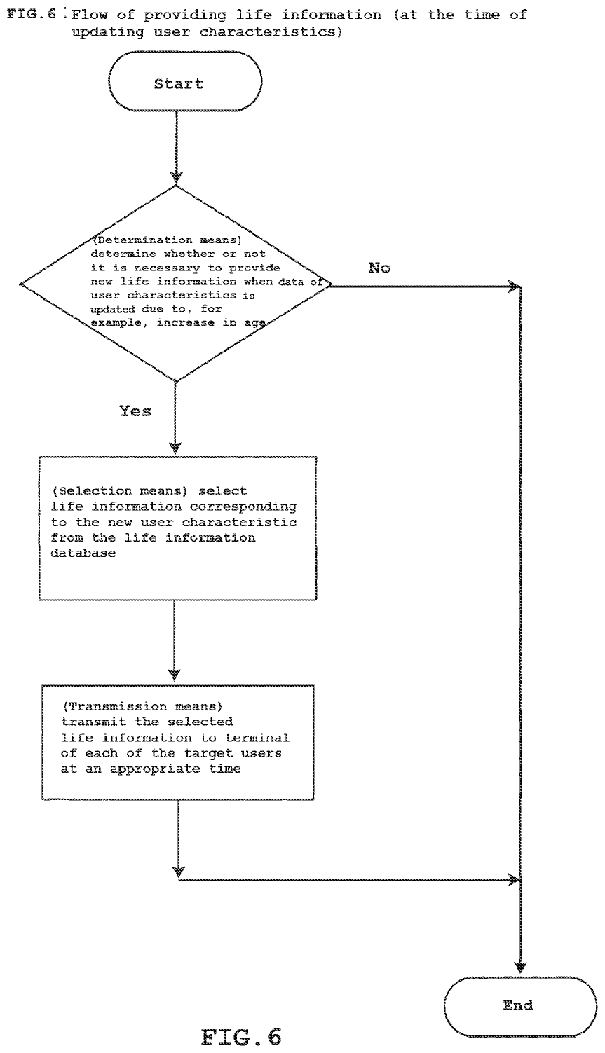

When the data of the registered user characteristics is updated, the life information is provided according to the flow of FIG. 6. In other words, when the data of the registered user characteristics is updated due to an increase in age, or when a person becomes a new registered user, it is determined whether it is necessary to newly provide the life information. If it is determined that it is necessary to newly provide the life information, the life information corresponding to the new user characteristics is selected from the life information database and transmitted to the terminal of the target user at an appropriate time.

For example, when a user reaches the age of entering an elementary school in the near future, the life information related to group life (to be in the item of bullying) and traffic accidents on the school road, which are to be in the items of the unsafe factor in the environment of the elementary school, is transmitted to the user about 1 to 2 months prior to the start of the elementary school.

When a person becomes a new registered user, the user is provided with the life information up to now over all items as an update from the state where the user has not received any life information at all.

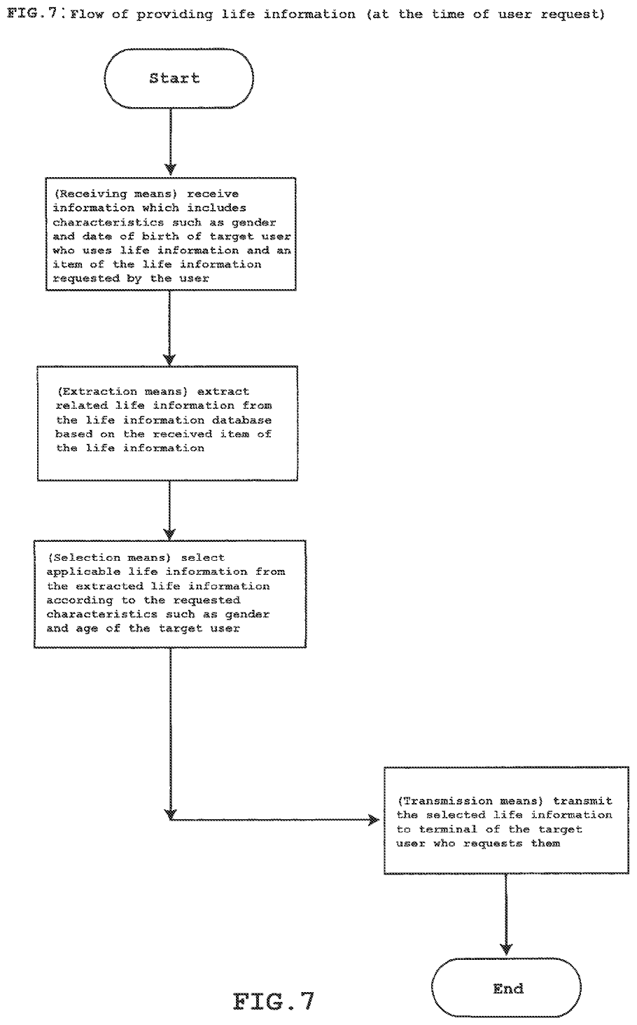

When a user wants information of the unsafe factors at domestic or overseas visits, the life information is provided according to the flow shown in FIG. 7. In other words, the user inputs information including a desired item of the life information, region, and user characteristics such as gender and date of birth of the target person (user) using the life information and sends the inputted information to the life information providing device. The life information providing device receives it to extract the related life information from the life information database based on the item of the received life information. Further, the life information providing device selects applicable life information from the extracted life information according to the requested characteristics such as the gender and the date of birth of the target person. Furthermore, the life information providing device transmits the selected life information to the terminal of the user who requests the selected life information.

If life information of endemic diseases in overseas countries is officially provided by the Ministry of Foreign Affairs, the life information will be introduced.

There are several types of abuse and bullying. For example, “parent-to-child abuse”, “husband-to-wife domestic violence”, “bullying in group life such as elementary schools, junior high schools, high schools and universities”, “power harassment and sexual harassment within companies”, and “stalking between individuals”. With respect to them, there are child guidance centers, boards of education, police, and private consultation counters. However, it is difficult to determine where to consult for the best response, and some users may not want to make such information public.

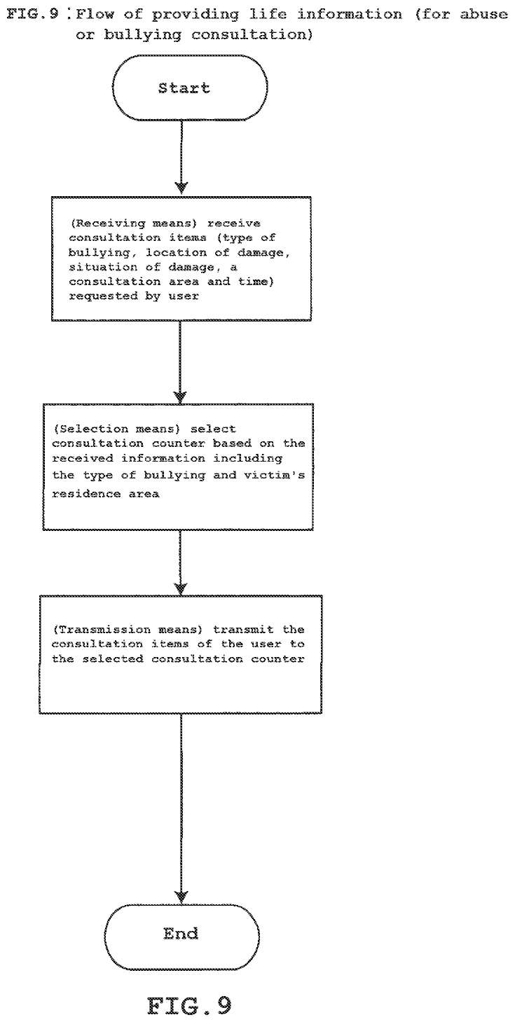

If a user is being abused or bullied and wants to consult with a consultation counter, a consultation request (bullying type, location of damage, situation of damage, a consultation area and time zone) is sent to the life information providing device as shown in FIG. 9. Then, the life information providing device receives it, selects the most suitable consultation counter based on the type of bullying and the location of the damage, and sends the consultation request to the consultation counter.

By doing so, the consultation counter can contact with the user. As a result, the user can consult the consultation counter to receive the best advice and protection according to his/her circumstances. If the user goes to the consultation counter, the user can let the consultation counter know it in advance. Thereby, a place of consultation will be adjusted by the consultation counter to send the information of the place to the user. In contrast, it is extremely difficult for a child to consult about abuse from the parent to the child. Therefore, the type of bullying, the name and address of the victim may be transmitted to the life information providing device from a person who recognizes the abuse, such as a neighbor. Then, the life information providing device receives the information and sends a message to the local child guidance center stating that there is a risk of abuse from the parent to the child. This allows the child guidance center to take appropriate action for his/her circumstances.

### EXPLANATION OF REFERENCE NUMERALS

1. Category: Category set to list a wide range of unsafe factors of human life
2. Danger level: Danger level set to clarify response priority in such a way of dividing the listed unsafe factors into immediate death level, lethality level, long-term rest level, short-term rest level and no rest required level according to the degree of danger.

1. A life information providing device for transmitting information to specific users to be target persons for the information who are associated with target-person characteristics such as gender, date of birth and a residence area, the information being issued by information providing organizations such as national and local governments, academic organizations and news organizations, the life information providing device being configured to transmit the information as life information which is classified into items of each of unsafe factors such as illness, child abuse or a traffic accident harming safety of human life to the target persons, wherein the life information providing device comprising:
a life information database in which the life information is registered and saved together with the characteristics of gender, the date of birth and a region of each of the target persons for the life information in such a way of classifying the unsafe factors through a wide range of fields, dividing the unsafe factors into the items and organizing the life information by each of the items, and in which previous life information has been registered and saved in advance;
a registered user database in which data of user characteristics is registered and saved, the user characteristics including name, gender, date of birth, a residence are, an activity area of each of the users, as well as information related to a vaccination and a traffic safety course taken by each user,
receiving means for receiving new information issued by the information providing organizations as new life information;
specifying means for specifying the item of the unsafe factor which causes the received new life information from the received new life information by dividing the items into any one of five risk levels which include immediate death level, lethality level, long-term rest level, short-term rest level and no rest required level;
registration means 1 for converting the received new life information into electronic data and additionally registering the electronic data in the life information database according to the specified item of the unsafe factor;
extraction means for extracting target-person characteristics from the new life information;
registration means 2 for registering the target-person characteristics extracted by the extraction means in the life information database as attached data of the new life information;
selection means for selecting users who match the target-person characteristics extracted by the extraction means from the registered user database; and
transmission means for transmitting the new life information to a terminal of each of the selected users,
wherein the new life information and the previous life information of the specified unsafe factor are provided to the target users together with the registered user information without delay after issuing the life information or without failure to receive the life information.

2. The life information providing device according to claim 1 further comprising:
determination means for determining whether or not it is necessary to provide new life information corresponding to a new user characteristic when the user characteristics change due to, for example, an increase in the age of the registered users;
selection means for selecting the new life information corresponding to the new user characteristic from the life information database, when it is determined that the new life information needs to be provided; and
transmission means for transmitting the selected new life information to the terminal of each of the target users at an appropriate time.

3. The life information providing device according to claim 1 further comprising:
receiving means for receiving information which includes the user characteristics such as the gender and the date of birth of a target user who uses the life information and an item of the life information requested by the user, such that when the user wants to newly obtain the life information of domestic or overseas visits, the user can receive the requested information by inputting and transmitting a request to the life information providing device;
extraction means for extracting related life information from the life information database based on the received item of the life information;
selection means for selecting applicable life information from the extracted life information according to the requested user characteristics such as the gender and the age of the target user; and
transmission means for transmitting the selected life information to the terminal of the target user who requests the life information.

4. The life information providing device according to claim 1 further comprising:
receiving means for receiving information of consultation items (type of bullying, location of damage, situation of damage, a consultation area and time zone) requested by a user, such that when the user is abused or bullied and wants to consult with a consultation counter, the user can receive the requested information by inputting and transmitting a request to the life information providing device;
selection means for selecting the most suitable consultation counter based on the type of bullying and the location of damage in the received information; and
transmission means for transmitting a consultation request to the selected consultation counter.

5. The life information providing device according to claim 2 further comprising:
receiving means for receiving information which includes the user characteristics such as the gender and the date of birth of a target user who uses the life information and an item of the life information requested by the user, such that when the user wants to newly obtain the life information of domestic or overseas visits, the user can receive the requested information by inputting and transmitting a request to the life information providing device;
extraction means for extracting related life information from the life information database based on the received item of the life information;
selection means for selecting applicable life information from the extracted life information according to the requested user characteristics such as the gender and the age of the target user; and
transmission means for transmitting the selected life information to the terminal of the target user who requests the life information.

6. The life information providing device according to claim 2 further comprising:
receiving means for receiving information of consultation items (type of bullying, location of damage, situation of damage, a consultation area and time zone) requested by a user, such that when the user is abused or bullied and wants to consult with a consultation counter, the user can receive the requested information by inputting and transmitting a request to the life information providing device;
selection means for selecting the most suitable consultation counter based on the type of bullying and the location of damage in the received information; and
transmission means for transmitting a consultation request to the selected consultation counter.
